(19) United States
(12) Patent Application Publication
(10) Pub. No.: US 2026/0196713 A1
(43) Pub. Date: Jul. 9, 2026

(54) Wearable Devices with Antenna Assembly and Manufacturing Methods Thereof

(71) Applicant: Anhui Huami Health Technology Co., Ltd., Hefei (CN)

(72) Inventors: Pengfei Xu, Hefei (CN); Jiayu Li, Hefei (CN); Anping Zhao, Hefei (CN)

(21) Appl. No.: 19/550,776

(22) Filed: Feb. 26, 2026

Related U.S. Application Data
(63) Continuation of application No. PCT/CN2024/143724, filed on Dec. 30, 2024.

(30) Foreign Application Priority Data
Dec. 29, 2023 (CN) 202323667775.8

(51) Int. Cl. H01Q 1/27; G01S 19/32; G01S 19/36; H01Q 5/30

(52) U.S. Cl. CPC H01Q 1/273; G01S 19/32; G01S 19/36; H01Q 5/30

(57) ABSTRACT

A wearable device and a manufacturing method thereof are provided. The wearable device includes a housing, an antenna assembly, and a main board. The housing includes a middle frame and a bottom case formed from an electrically insulating material. The antenna assembly includes at least two antenna brackets and at least two antenna radiators, and the at least two antenna brackets are symmetrically disposed at the middle frame relative to a center of the middle frame. The at least two antenna radiators are disposed on the at least two antenna brackets respectively. The main board is electrically connected to the at least two antenna radiators to form at least two positioning antennas associated with different operating frequency bands, where each of the at least two positioning antennas associated with different operating frequency bands is configured on a different one of the antenna brackets.

### CROSS-REFERENCE TO RELATED APPLICATION(S

The present disclosure is a continuation of International Application No. PCT/CN2024/143724, filed on December 30, 2024, which claims priority and benefit of Chinese Patent Application No. 202323667775.8, filed December 29, 2023, the entire disclosures of both of which are hereby incorporated by reference.

### TECHNICAL FIELD

The present disclosure relates to the field of portable electronic device technologies, and in particular, to wearable devices and manufacturing methods thereof.

### BACKGROUND

Currently, positioning functions have gradually become standard configurations in wearable devices. To achieve fast and accurate positioning, a dual-band GPS function is usually configured in wearable devices.

### SUMMARY

The present disclosure provides a wearable device with excellent antenna isolation and a manufacturing method thereof.

One aspect of the present disclosure provides a wearable device, including: a housing, where the housing includes a middle frame and a bottom case that are formed from an electrically insulating material; an antenna assembly, where the antenna assembly includes at least two antenna brackets and at least two antenna radiators, the at least two antenna brackets being symmetrically disposed at the middle frame relative to a center of the middle frame, and the at least two antenna radiators being disposed on a corresponding one of the at least two antenna brackets; and a main board, electrically connected to the at least two antenna radiators to form at least two positioning antennas associated with different operating frequency bands, where each of the at least two positioning antennas associated with different operating frequency bands is configured on a different one of the at least two antenna brackets.

Another aspect of the present disclosure provides a method for manufacturing a wearable device, including: providing an antenna bracket; obtaining an antenna assembly by disposing an antenna radiator on at least one surface of the antenna bracket; obtaining a middle frame by injection molding the antenna assembly into a middle frame of the wearable device; and assembling the middle frame with a bottom case to obtain the wearable device.

In the wearable device provided in the present disclosure, the at least two antenna brackets are symmetrically disposed at the middle frame, the at least two antenna radiators of the antenna assembly are disposed on the at least two antenna brackets respectively, the at least two antenna radiators are electrically connected to the main board to form the at least two positioning antennas associated with different operating frequency bands, and the at least two positioning antennas associated with different operating frequency bands are configured on different antenna brackets, resulting in excellent antenna isolation. Moreover, the at least two positioning antennas associated with different operating frequency bands are realized in limited space of the wearable device, allowing for independent tuning of the operating frequencies thereof without affecting each other, thus maximizing antenna performance of each positioning antenna.

It is to be understood that, both the foregoing general description and the following detailed description are merely exemplary and explanatory, and are not intended to limit the present disclosure.

### BRIEF DESCRIPTION OF THE DRAWINGS

The accompanying drawings are incorporated into and constitute a part of this specification, illustrate implementations consistent with the present disclosure and, together with the description, serve to explain the principles of the present disclosure.

FIG. 1 is a schematic structural diagram of a wearable device according to some implementations of the present disclosure.

FIG. 2 is another schematic structural diagram of the wearable device according to some implementations of the present disclosure.

FIG. 3 is another schematic structural diagram of the wearable device according to some implementations of the present disclosure.

FIG. 4 is a schematic structural diagram of an antenna bracket of the wearable device according to some implementations of the present disclosure.

FIG. 5 is another schematic structural diagram of the wearable device according to some implementations of the present disclosure.

FIG. 6 is another schematic structural diagram of the wearable device according to some implementations of the present disclosure.

FIG. 7 is another schematic structural diagram of the wearable device according to some implementations of the present disclosure.

FIG. 8 is a schematic diagram of current distribution of an antenna assembly according to some implementations of the present disclosure.

FIG. 9 is a schematic diagram of a standing wave ratio of an L1-band positioning antenna of the wearable device according to some implementations of the present disclosure.

FIG. 10 is a schematic diagram of a standing wave ratio of an L5 band positioning antenna of the wearable device according to some implementations of the present disclosure.

FIG. 11 is a schematic diagram of isolation between a positioning antenna associated with GPS L1-band and a positioning antenna associated with GPS L5-band in the wearable device according to some implementations of the present disclosure.

FIG. 12 is another schematic structural diagram of the wearable device according to some implementations of the present disclosure.

FIG. 13 is another schematic structural diagram of the wearable device according to some implementations of the present disclosure.

FIG. 14 is another schematic structural diagram of the wearable device according to some implementations of the present disclosure.

FIG. 15 is another schematic structural diagram of the wearable device according to some implementations of the present disclosure.

FIG. 16 is another schematic structural diagram of the wearable device according to some implementations of the present disclosure.

FIG. 17 is another schematic structural diagram of the wearable device according to some implementations of the present disclosure.

### DETAILED DESCRIPTION

Exemplary implementations will be described in detail herein with reference to the accompanying drawings. When the following description refers to the accompanying drawings, unless otherwise indicated, a same number in different drawings indicates the same or similar elements. The exemplary implementations described below do not represent all implementations consistent with the present disclosure. Rather, they are merely examples of apparatuses and methods consistent with some aspects of the present disclosure as detailed in the appended claims.

The terms used in the present disclosure are merely for the purpose of describing specific implementations, and are not intended to limit the present disclosure. Unless otherwise stated, the technical terms or scientific terms used in the present disclosure shall have the ordinary meanings understood by those of ordinary skill in the art to which the present disclosure belongs. The terms “first”, “second” and the like used in the specification and claims of the present disclosure do not indicate any order, quantity, or importance, but are merely used to distinguish different components or objects. The term “a” or “an” or the like does not indicate a quantity limitation, but indicates at least one. The term “a plurality of” or “several” means two or more. Unless otherwise indicated, terms such as “front”, “rear”, “lower”, and/or “upper” are merely for convenience of description, and are not limited to one position or one spatial orientation. The terms “A including B” and “A comprising B” and the like indicate that A includes B and its equivalent, and does not exclude other elements or objects. The term “connect to” or “coupled to” or the like is not limited to physical or mechanical connections, but may include electrical connections, whether direct or indirect.

The terms used in the present disclosure are merely for the purpose of describing specific implementations, and are not intended to limit the present disclosure. As used in the present disclosure and the appended claims, the singular forms associated with the terms “a”, “an” and “the” are intended to include the plural forms as well, unless the context clearly indicates otherwise. It should also be understood that the term “and/or” used herein refers to and includes any one or all possible combinations of one or more listed items.

In some implementations of the present disclosure, a wearable device is provided, including: a housing, an antenna assembly, and a main board. The housing includes a bottom case and a middle frame formed from an insulating material. The antenna assembly includes at least two antenna brackets and at least two antenna radiators, and the at least two antenna brackets are symmetrically disposed at the middle frame. The at least two antenna radiators are respectively disposed on the at least two antenna brackets. The main board is electrically connected to the at least two antenna radiators to form at least two positioning antennas associated with different operating frequency bands. The at least two positioning antennas associated with different operating frequency bands are distributed on different antenna brackets. In some implementations, the at least two antenna brackets are symmetrically disposed at the middle frame relative to a center of the wearable device. For a circular wearable device, the center of the wearable device is the center of the circle. For a rectangular wearable device, the center of the wearable device is the center of the rectangle. For wearable devices of other shapes, the center of the wearable device is the center of the shape. In some implementations, the at least two antenna brackets are symmetrically disposed at the middle frame relative to a symmetry axis of the wearable device.

In the wearable device provided in these implementations of the present disclosure, the at least two antenna brackets are symmetrically disposed at the middle frame, the at least two antenna radiators of the antenna assembly are respectively disposed on the at least two antenna brackets, and are electrically connected to the main board to form the at least two positioning antennas associated with different operating frequency bands. The at least two positioning antennas associated with different operating frequency bands are distributed on different antenna brackets, so as to achieve relatively good isolation, and the at least two positioning antennas associated with different operating frequency bands can be implemented within the limited space of the wearable device, allowing for independent tuning of the operating frequencies thereof without affecting each other, thus maximizing antenna performance of each positioning antenna.

The wearable device provided by the present disclosure will be described in detail below with reference to the accompanying drawings. The features in the following various examples and implementations can be arbitrarily combined without conflict.

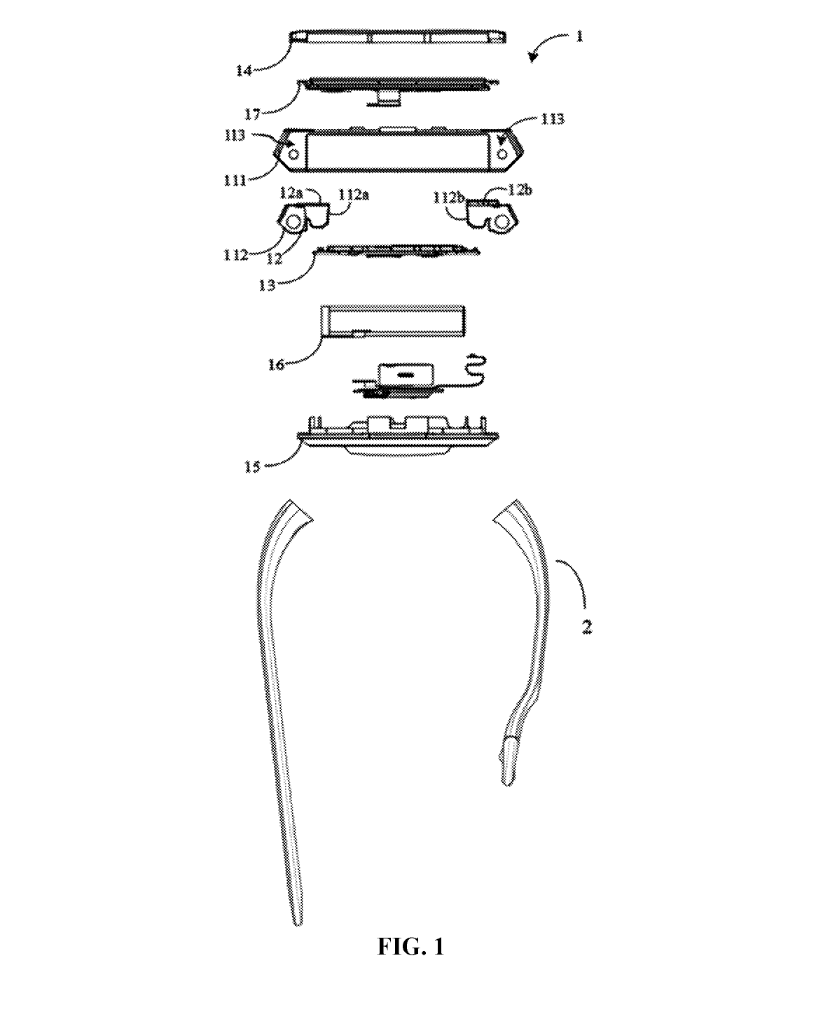

FIG. 1 is a schematic structural diagram of a wearable device 1 according to some implementations of the present disclosure. The wearable device 1 described below includes a wrist-worn device, such as, for example, a circular watch is used as an example for description. In some other implementations, the wearable device 1 may be a wristwatch or a wristband of any shape, such as, for example, a square, a hexagon, or an octagon, or the like, which is not limited in the present disclosure.

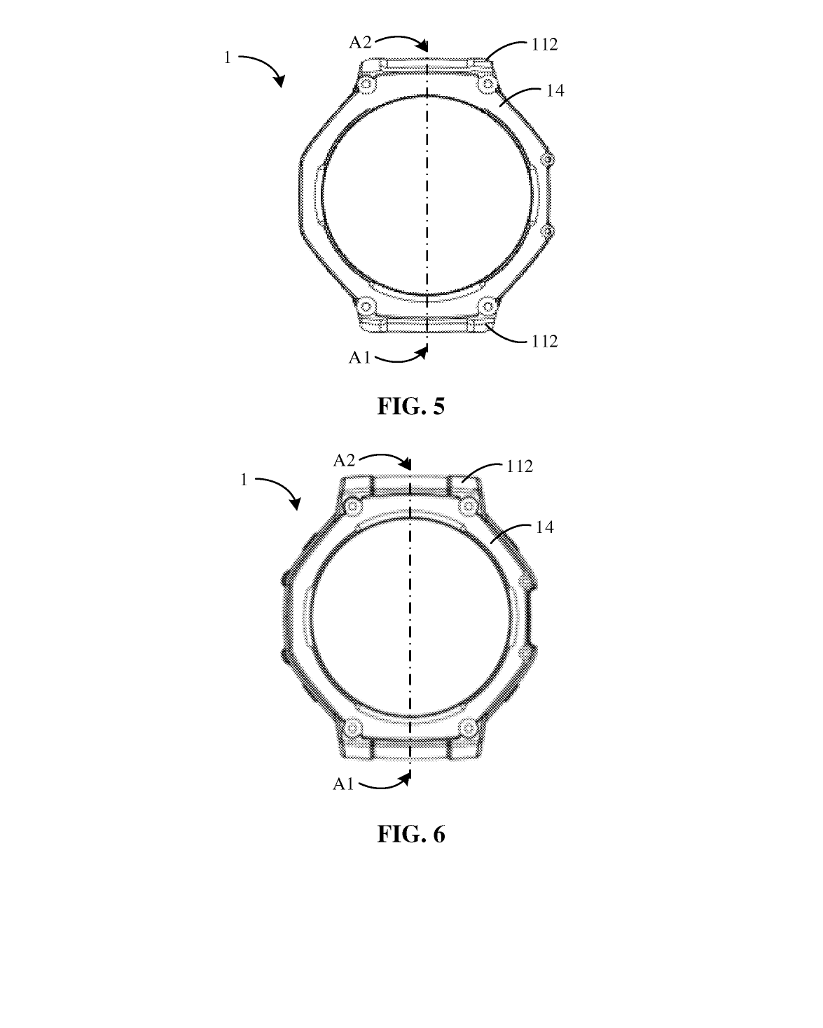

As shown in FIGS. 1 to 7, the wearable device 1 includes a housing, an antenna assembly, and a main board 13. The housing includes a middle frame 111 formed from an insulating material and a bottom case 15. The antenna assembly includes at least two antenna brackets 112 and at least two antenna radiators 12, and the at least two antenna brackets 112 are symmetrically disposed at the middle frame 111. The at least two antenna radiators 12 are respectively disposed on the at least two antenna brackets 112. The main board 13 is connected to the middle frame 111. The at least two antenna radiators 12 are electrically connected to the main board 13 to form at least two positioning antennas with different operating frequency bands. The at least two positioning antennas with different operating frequency bands are distributed on different antenna brackets 112. In some implementations, the antenna bracket may have a three-dimensional configuration as needed and have a plurality of surfaces with different orientations. In some implementations, the main board is located between the at least two antenna brackets and the bottom case. In this way, the at least two antenna brackets are disposed closer to the top surface of the wearable device.

In some implementations, the wearable device 1 further includes a wearable attachment 2, and the wearable attachment 2 is configured to secure the wearable device 1 to a human body such as a user of the wearable device. The housing includes at least one connection portion 18 configured for connecting the wearable attachment 2. The at least two antenna brackets 112 include one or more antenna brackets 112 arranged within the connection portion. In the example shown in FIG. 1, the at least two antenna brackets 112 include a first antenna bracket 112a and a second antenna bracket 112b, and the at least two antenna radiators 12 include a first antenna radiator 12a and a second antenna radiator 12b. The first antenna radiator 12a forms a first positioning antenna and a wireless communication antenna respectively, and the second antenna radiator 12b symmetrically arranged with the first antenna radiator 12a forms a second positioning antenna. The first antenna radiator 12a is disposed on the first antenna bracket 112a, and the second antenna radiator 12b is disposed on the second antenna bracket 112b. The first antenna bracket 112a and the second antenna bracket 112b are symmetrically arranged in two opposite directions of the middle frame 111. Correspondingly, the first antenna radiator 12a and the second antenna radiator 12b are symmetrically arranged in two opposite directions of the middle frame 111. The first antenna radiator 12a and the second antenna radiator 12b are electrically connected to the main board 13 to form a plurality of antennas with at least two different operating frequency bands. In this way, at least two positioning antennas with different operating frequency bands are arranged on different antenna brackets 112. The at least two antenna brackets 112 carry the at least two antenna radiators 12 and are electrically connected to the main board 13, so that the at least two positioning antennas with different operating frequency bands have a better isolation, and in a limited space of the wearable device 1, the at least two positioning antennas with different operating frequency bands can be separately tuned without affecting each other, which is conducive to maximizing antenna performance of each positioning antenna and realizing the dual-band positioning function.

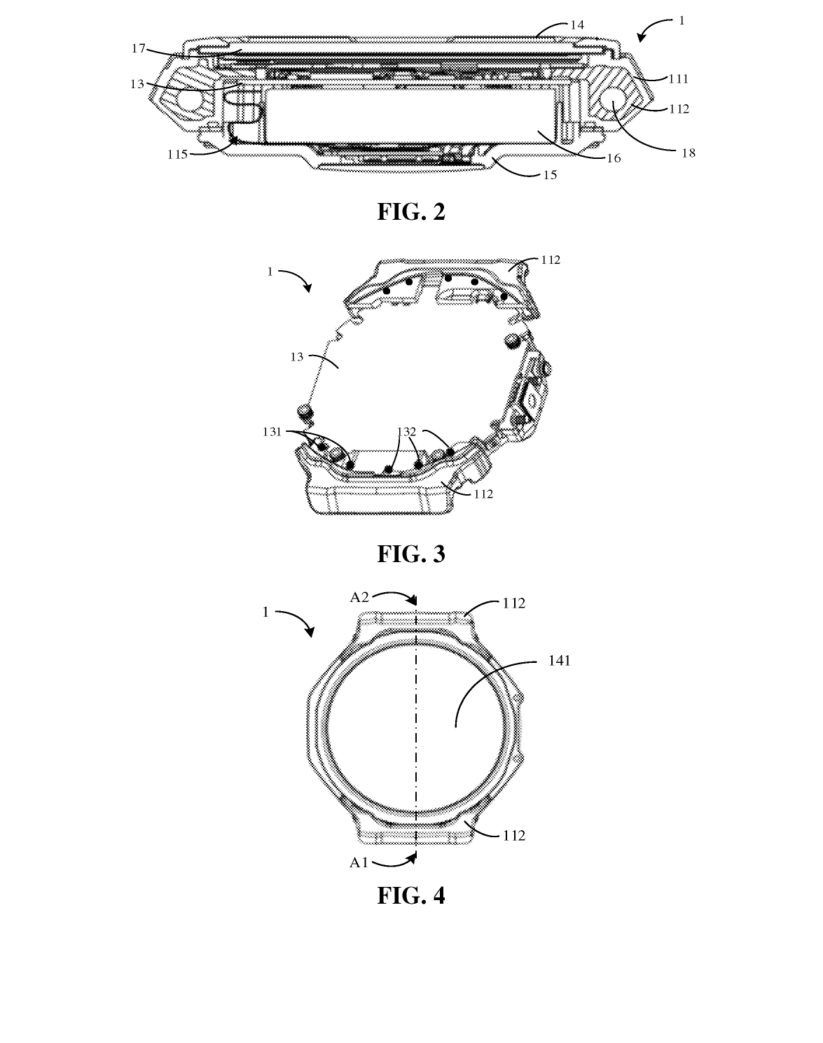

With reference to the example shown in FIG. 1 and FIG. 2, the middle frame 111 includes a bracket accommodating portion 113 having at least two uniformly distributed bracket accommodating sections corresponding to the first antenna bracket 112a and the second antenna bracket 112b respectively. One part of the antenna bracket 112 is embedded in the bracket accommodating portion 113 by injection molding, and the other part extends out of the bracket accommodating portion 113. In this implementation, two opposite portions of the middle frame 111 are provided with a bracket accommodating portion 113, and the antenna bracket 112 is partially embedded in the bracket accommodating portion 113 by injection molding and partially extended out of the bracket accommodating portion 113. This arrangement is simple and stable.

In some implementations, the middle frame 111 is provided with at least two uniformly distributed bracket accommodating portions, including the bracket accommodating portion 113, and the antenna bracket 112 is embedded in the bracket accommodating portion 113 by injection molding. Since the antenna bracket has a three-dimensional configuration, the bracket accommodating portion adapted to the shape of the antenna bracket is disposed at the middle frame to facilitate the embedding of the antenna bracket in the middle frame. In some implementations, the middle frame 111 and the antenna bracket 112 are of an integrated structure. The integrated structure is simple and highly integrated. In some implementations, the middle frame 111 wraps around an outer side of the antenna bracket 112. In this way, the antenna bracket 112 can be wrapped inside, and the appearance is concise.

With reference to the examples shown in FIG. 1 and FIG. 2, the wearable device 1 further includes a top cover component 14, a battery assembly 16, and a screen assembly 17. The top cover component 14 is arranged on the top of the middle frame 111 and disposed around the screen assembly 17. The bottom case 15 is arranged at the bottom of the middle frame 111. In some implementations, the middle frame 111 is made of a plastic material. The plastic frame has low cost and is lightweight. The middle frame 111 may be formed from another type of electrically insulating material, which is not limited herein. The top cover component 14 may also be referred to as a bezel, and a decorative component may be disposed on the top cover component 14. The top cover component 14 is arranged on a first surface of the middle frame 111. The bottom case 15 may also be referred to as a rear cover component, and is arranged on a second surface of the middle frame 111 opposite to the first surface. The top cover component 14, the middle frame 111, and the bottom case 15 may surround to define an accommodating space 115, and a plurality of electronic components are accommodated in the accommodating space, including a main board 13, a speaker, a motor, a battery assembly 16, a charging component, and/or the like. With this arrangement, the internal space of the accommodating space 115 is effectively utilized, the wiring is flexible, and the structural layout is compact.

In the example shown in FIG. 1 and FIG. 2, the battery assembly 16, the main board 13, and the screen assembly 17 are sequentially stacked in a direction extending from the bottom case 15 toward the top cover component 14. With this arrangement, the space of the accommodating space 115 is effectively utilized, and the structural layout is compact. In some implementations, there is a gap between the main board 13 and each of the screen assembly 17 and the battery assembly 16. By setting the gap, heat dissipation is facilitated while meeting electrical requirements of the wearable device. In some implementations, the top cover component 14 includes a transparent window 141, and the screen assembly 17 is disposed corresponding to the transparent window 141. The top cover component 14 is disposed on the top of the wearable device 1, and an edge of the top cover component 14 is clamped to an edge of the middle frame 111. An edge of the screen assembly 17 is clamped to an edge of the middle frame 111. This assembling method with clamping results in a simple structure, a reduced number of components, a compact structure and low cost. In some other implementations, the screen assembly 17, the top cover component 14, and the middle frame 111 may be connected in other manners, which is not limited in the implementations of the present disclosure.

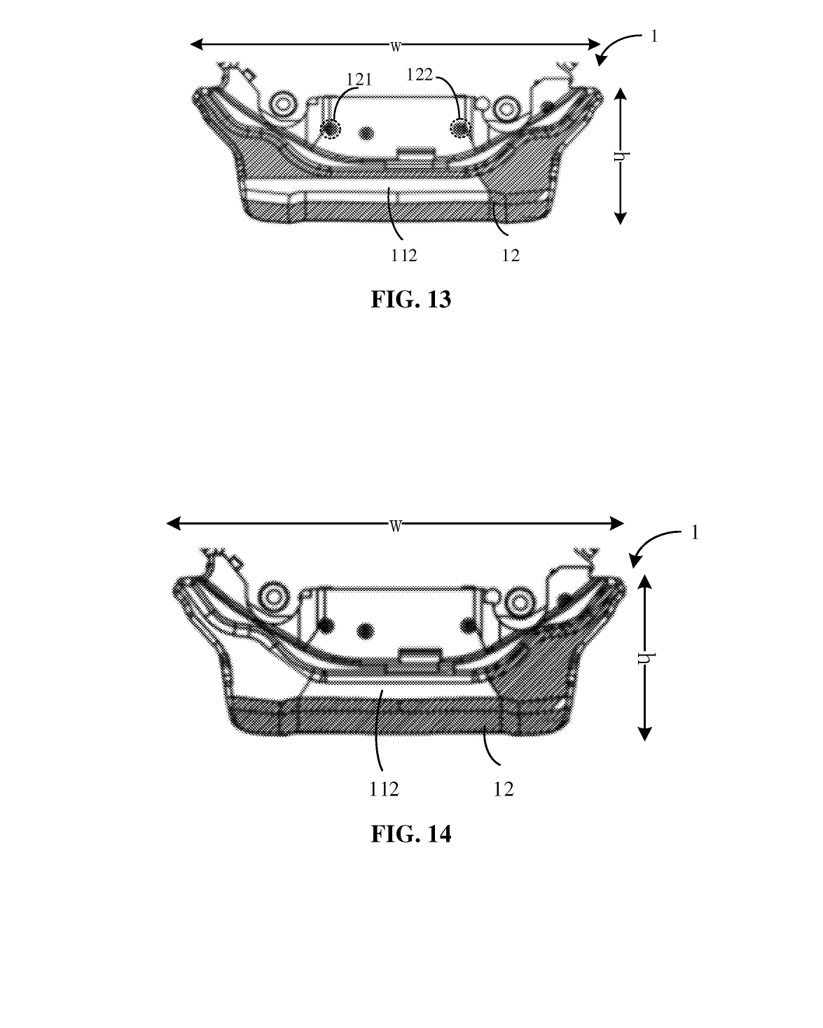

In the examples shown in FIGS. 1 to 3, an edge of the main board 13 is connected to an inner edge of the middle frame 111. A plurality of feeding terminals 131 and a plurality of grounding terminals 132 are disposed on the main board 13. The plurality of feeding terminals 131 and the plurality of grounding terminals 132 may be disposed on a side facing the top cover component 14, and are relatively close to an inner edge of the middle frame 111 and spaced apart from each other. Each antenna radiator 12 includes at least one feeding point 121 and at least one grounding point 122, which are shown by dashed lines in FIG. 13 and located below the feeding terminals 131 and the grounding terminals 132. The main board 13 includes a plurality of feeding terminals 131 connected to a plurality of feeding points of the at least two antenna radiators 12 and a plurality of grounding terminals 132 connected to a plurality of grounding points of the at least two antenna radiators 12. The plurality of feeding points are electrically connected to the plurality of feeding terminals 131, and the plurality of grounding points are electrically connected to the plurality of grounding terminals 132. The feeding point is configured to feed antenna signals and is electrically connected to a circuit layer of the main board 13. The grounding point is electrically connected to a grounding layer of the main board 13. The plurality of feeding terminals 131 and the plurality of grounding terminals 132 are arranged on the side facing the top cover component 14, which facilitates their electrical connections to the antenna radiator 12, achieving shorter electrical paths and a more compact structure.

In some implementations, to achieve frequency tuning, the shape of the antenna radiator 12 disposed on the antenna bracket 112 may be adjusted, and positions of the feeding terminals 131 and the grounding terminals 132 may be properly selected, thereby providing a simple frequency tuning method, and achieving favorable isolation performance.

In some implementations, the at least two antenna radiators 12 include a first antenna radiator 12a and a second antenna radiator 12b. At least one feeding point and at least one grounding point disposed on the first antenna radiator 12a are respectively coupled to the main board 13. The second antenna radiator 12b is coupled to a feeding terminal 131 on the main board 13 through at least one feeding point, or is coupled to a grounding terminal 132 on the main board 13 through at least one grounding point. The first antenna radiator 12a and the second antenna radiator 12b may be associated with different grounding points and feeding points, and are connected to different feeding terminals 131 and grounding terminals 132 on the main board 13. The main board 13 is connected to the feeding point through the feeding terminal 131, and is connected to the grounding point through the grounding terminal 132, which is stable and reliable.

In some implementations, the bottom case 15 is formed from an electrically insulating material. A plurality of electrically conductive components are disposed on the bottom case 15, and are electrically connected to the main board 13. At least one of the at least two antenna radiators 12 is connected to the main board 13 via at least one of the plurality of conductive components. The electrical connection is achieved by providing the conductive component, with the advantage of a simple structure and low cost.

In some implementations, the at least two positioning antennas associated with different operating frequency bands include a first positioning antenna operating at a GPS L1 frequency band and a second positioning antenna operating at a GPS L5 frequency band. In the implementations, the dual-frequency GPS refers to positioning that simultaneously supports both the GPS L1 frequency band and the GPS L5 frequency band. In some examples, the GPS L1 frequency band is 1575.42±1.023 MHz, and the GPS L5 frequency band is 1176.45±1.023 MHz. Due to its longer wavelength, the GPS L5 signal experiences less attenuation in free space, thus providing higher receiving power of the positioning signals at the ground device under the same condition. The received signal power associated with the GPS L5 frequency band may be 6 dB higher than that associated with the GPS L1 frequency band under identical conditions. However, since the GPS L1 frequency band is associated with a wider satellite coverage, the GPS L1 frequency band is usually adopted as a primary operating frequency band for GPS positioning, and the GPS L5 frequency band is adopted as an auxiliary to the GPS L1 frequency band.

In some implementations, the first antenna radiator 12a may be configured to implement a positioning antenna operating at the GPS L1 frequency band, and the second antenna radiator 12b may be configured to implement a positioning antenna operating at the GPS L5 frequency band. The first positioning antenna operating at the GPS L1 frequency band and the second positioning antenna operating at the GPS L5 frequency band are distributed on different antenna brackets 112, which can improve the isolation between the first positioning antenna and the second positioning antenna. Moreover, within the limited space of the wearable device 1, the operating frequency bands of the at least two positioning antennas can be independently tuned without mutual interference, thereby maximizing the antenna performance of each positioning antenna.

In the examples shown in FIGS. 4 to 6, the wearable device 1 includes a wrist-worn device. The wrist-worn device includes a 6 o'clock position A1 and a 12 o'clock position A2. The 6 o'clock position A1 and the 12 o'clock position A2 are symmetrically oriented. For example, the 6 o'clock position A1 may be oriented to a true south direction. The 12 o'clock position A2 may be oriented to a true north direction. In some implementations, the at least two antenna brackets 112 are symmetrically arranged at the 6 o'clock position A1 and the 12 o'clock position A2 of a dial of the wearable device 1. For example, the first positioning antenna operating at the GPS L1 frequency band and the second positioning antenna operating at the GPS L5 frequency band are respectively arranged at the 6 o'clock position A1 and the 12 o'clock position A2 of the wearable device 1. In some examples, the first positioning antenna operating at the GPS L1 frequency band is arranged at the 6 o'clock position A1 of the wearable device 1, and the second positioning antenna operating at the GPS L5 frequency band is arranged at the 12 o'clock position A2 of the wearable device 1. In some other examples, the first positioning antenna operating on the GPS L1 frequency band is arranged at the 12 o'clock position A2 of the wearable device 1, and the second positioning antenna operating on the GPS L5 frequency band is arranged at the 6 o'clock position A1 of the wearable device 1. In this way, the positioning antenna operating on the GPS L1 frequency band and the positioning antenna operating on the GPS L5 frequency band can be flexibly set as required.

In some implementations, the wearable device 1 includes a connection portion for attaching the wearable attachment, such as a watch band. The connection portion may be provided at the 6 o'clock position A1 and the 12 o'clock position A2. These attachment areas typically have a lower spatial footprint requirement than other edge regions. Therefore, the antenna bracket may be provided in the region where the connection portion is located. For example, the antenna bracket may extend inside the connection portion along the direction of the connection portion attaching the wearable attachment, and may be designed as a three-dimensional structure, providing expandable or elongated space that can be adapted to different antenna components based on spatial requirements. The at least two antenna brackets are disposed in the area of the connection portion of the wearable device 1, so that internal space of the wearable device 1 can be effectively utilized, allowing for a compact structural layout, and facilitating device miniaturization.

In some implementations, the connection portion may be integrally disposed with the middle frame, or, the connection portion is disposed at the middle frame. The connection portion has a shape adapted to enclose the antenna bracket or adapted to a shape of the antenna bracket. In some other implementations of the present disclosure, the at least two antenna brackets may be disposed at other positions, which is not limited thereto.

In some implementations, the antenna bracket includes an opening configured to accommodate a spring bar connected to the wearable attachment. In some examples, one of the antenna brackets is provided with two opposite openings configured to accommodate the spring bars connected to the wearable attachment. For example, the spring bar is a slender rod and passes through the two opposite openings. The spring bar is configured for connecting to the wearable attachment. In some implementations, the connection portion defines an opening configured for accommodating the spring bar connected to the wearable attachment. In some examples, the connection portion includes a first connection portion and a second connection portion opposite to each other, and a third connection portion connecting the first connection portion and the second connection portion. The antenna bracket includes a first bracket portion provided on the first connection portion, a second bracket portion provided on the second connection portion, and a third bracket portion connecting the first bracket portion and the second bracket portion. The first bracket portion and the second bracket portion each includes an opening for accommodating a spring bar.

In some implementations, the electromagnetic field generated by the first positioning antenna operating on the GPS L1 frequency band has a current null symmetrical to that of the electromagnetic field generated by the second positioning antenna operating on the GPS L5 frequency band. The electromagnetic field generated by the first positioning antenna operating on the GPS L1 frequency band and the electromagnetic field generated by the second positioning antenna operating on the GPS L5 frequency band are symmetric with respect to a central point defined by a distribution direction of these two positioning antennas, e.g., centrosymmetric about the midpoint of a line segment connecting the first positioning antenna and the second positioning antenna. In the implementations, a distribution direction of electromagnetic fields of the first positioning antenna operating on the GPS L1 frequency band and the second positioning antenna operating on the GPS L5 frequency band may be a direction extended from the 6 o'clock position A1 to the 12 o'clock position A2. In some implementations, the electromagnetic field generated by the first positioning antenna and the electromagnetic field generated by the second positioning antenna are symmetrical about the center of the wearable device. In some implementations, the electromagnetic field generated by the first positioning antenna operating on the GPS L1 frequency band has a strongest strength in the area where the first positioning antenna is located, and has a weakest strength in the area where the second positioning antenna is located, so as to reduce the influence of the electromagnetic field of the first positioning antenna on the second positioning antenna. In some implementations, the electromagnetic field generated by the second positioning antenna operating on the GPS L5 frequency band has a strongest strength in the area where the second positioning antenna is located, and has a weakest strength in the area where the first positioning antenna is located, so as to reduce the influence of the electromagnetic field of the second positioning antenna on the first positioning antenna.

It can be seen from the example shown in FIG. 8 that, the current nulls corresponding to the first positioning antenna and the second positioning antenna are located in the 12 o'clock and the 6 o'clock regions. In this case, the currents of the electromagnetic fields of the first positioning antenna and the second positioning antenna are the weakest at the 12 o'clock position and the 6 o'clock position respectively, thereby minimizing the influence between the first positioning antenna and the second positioning antenna. In the implementations, the first positioning antenna operating on the GPS L1 frequency band is isolated from the second positioning antenna operating on the GPS L5 frequency band. As shown in FIG. 11, the first positioning antenna and the second positioning antenna do not affect each other, and exhibit good isolation. In this way, within the limited space of the wearable device 1, the at least two positioning antennas with different operating frequency bands can be independently tuned without affecting each other, allowing each antenna to achieve maximized performance.

In some implementations, the wearable device 1 further includes other types of antennas, such as a wireless communication antenna, which may include a long-range communication antenna or a short-range communication antenna, such as a cellular communication antenna, a Bluetooth antenna, a WiFi antenna, etc. In some examples, the wearable device 1 may include a wireless communication antenna operating on a 2.4 GHz frequency band (i.e., a frequency band centered at 2.4 GHz or approximately 2.4 GHz). The communication antenna operating on the 2.4 GHz frequency band may be an antenna configured for short-range wireless communications such as WiFi, Bluetooth, or Zigbee communications, and may transmit wireless signals within the 2.4 GHz frequency band, such as, for example, 2400-2483.5 MHz. The wireless communication antenna may be implemented by one of the at least two antenna radiators. In an example, the positioning antenna and the wireless communication antenna may be implemented by sharing a common antenna radiator. For example, the first antenna radiator of the at least two antenna radiators may concurrently implement the GPS positioning antenna operating on the GPS L1 band and the wireless communication antenna, which is not limited herein. In this way, the positioning antenna and the wireless communication antenna that cover different frequency bands can be realized simultaneously, thereby facilitating communication performance and miniaturization design of the wearable device.

In some implementations, the antenna radiator 12 is disposed on a corresponding antenna bracket 112. The antenna bracket 112 may be a plastic bracket embedded in the middle frame 111. The antenna bracket 112 is provided with a plurality of contact points for the antenna radiator, which are used for connecting to corresponding positions on the main board 13, such as, for example, via metal elastic pieces such as metal spring contacts. The metal spring contacts extend from the main board toward the top surface of the housing, and are in contact with, for example, abut against, the contact points of the antenna bracket 112, thereby establishing electrical connections between the main board 13 and the antenna bracket 112. By configuring an appropriate shape and corresponding contact point arrangement (e.g., the grounding terminal and the feeding terminal), the antenna radiator 12 enables both the first positioning antenna associated with the GPS L1 frequency band and the second positioning antenna associated with the GPS L5 frequency band of the dual-band GPS antenna system to operate at maximum performance while maintaining high isolation, thereby avoiding the compatibility issues inherent to co-designing the first positioning antenna associated with the L1 frequency band and the second positioning antenna associated with the L5 frequency band.

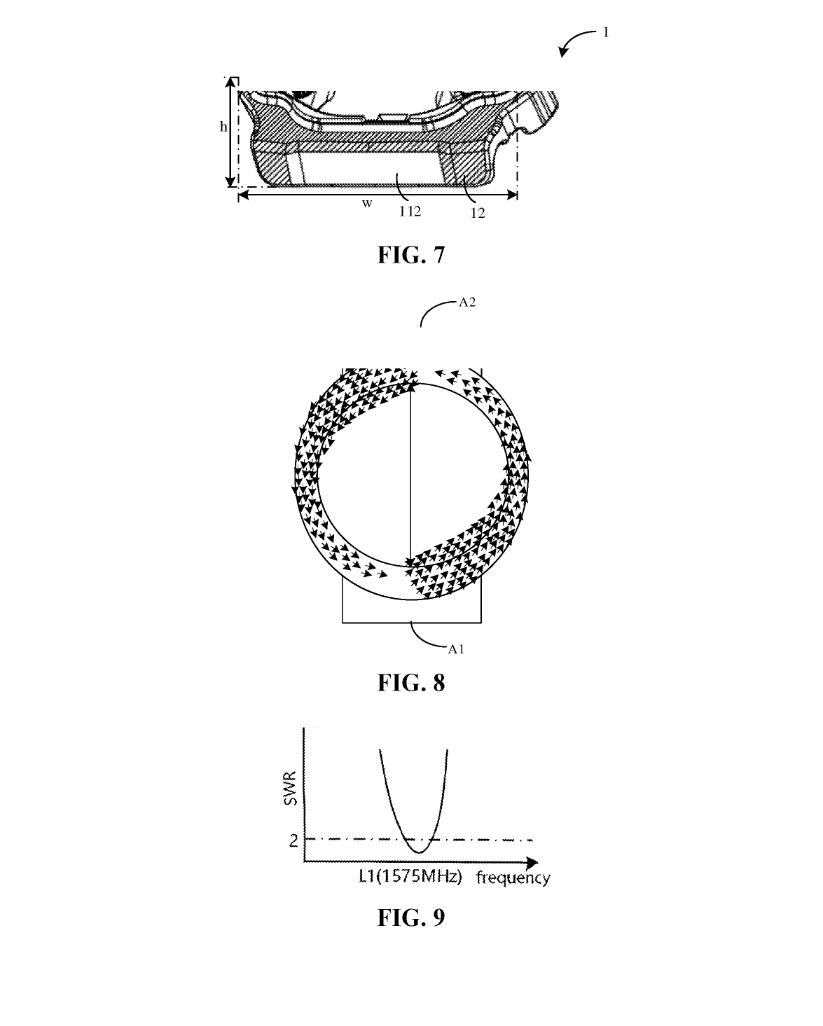

In the implementations of the present disclosure, the antenna radiator may be disposed on the antenna bracket in various manners. In the example shown in FIG. 7, the antenna radiator 12 is printed onto the surface of the antenna bracket 112 by using a printing direct structure (PDS) procedure. The antenna radiator 12 may be formed on the upper surface, the side surface, and/or the lower surface of the antenna bracket 112 via the PDS technique, which is not limited in the present disclosure. In some implementations, the antenna bracket 112 is a plastic bracket, and the antenna radiator 12 is formed by printing a metallic material onto a surface of the antenna bracket 112 through the PDS procedure. In this case, the antenna radiator 12 may be a metal component having a specific configuration.

PDS is a printing technique which, generally speaking, works like stamping. The stamping is used together with a metallic material (such as silver paste, nickel, gold or the like) to imprint a specific pattern onto the surface of the antenna bracket 112, and then cured. The process is simple, and imposes no requirement on the material of the antenna bracket 112, which can be implemented with a material suitable for injection molding, such as, for example, a plastic material. For antennas operating on different frequency bands, the antenna radiator 12 may be flexibly printed onto a surface of the antenna bracket 112 based on a structure of the antenna bracket 112, offering greater design flexibility and broader application scenarios.

In some implementations, the antenna bracket 112, the antenna radiator 12, and the middle frame are integrally formed. For instance, the antenna bracket 112 may be disposed at the middle frame, and then the antenna radiator 12 is disposed on the antenna bracket. Alternatively, the antenna bracket 112 and the antenna radiator 12 may be integrated together, and then the integrated antenna bracket 112 and antenna radiator 12 are disposed at the middle frame, for example, via injection molding or other procedures.

In some implementations, the antenna radiator 12 of a specific shape is printed onto the surface of the antenna bracket 112 via the PDS process, and then the antenna bracket 112 is injection molded into the middle frame 111 via a two-shot injection molding process. The two-shot injection molding process may involve first molding, for example, a plastic material in a first-shot plastic mold to form a component; the component is taken out and put into a second-shot mold where the same or different plastic material is injected to form the final component, which is simple in process and low in cost.

In some other implementations, the antenna radiator 12 may be disposed on the surface of the antenna bracket 112 by a procedure such as etching, electroplating, molding, hand lay-up, or the like, which is not limited in the present disclosure.

In some implementations, the antenna bracket 112 and the antenna radiator 12 are integrally formed as a unitary structure. The antenna radiator 12 is located on a surface of the antenna bracket 112, but this is not limited in the present disclosure. In the implementations of the present disclosure, an operating frequency band of the antenna formed by the antenna radiator may be adjusted in a variety of manners.

In some implementations, the antenna bracket is not a planar support, but rather a three-dimensional (3D) bracket. In an example, the at least one antenna bracket includes a first surface and a second surface, and the antenna radiator is disposed on at least a portion of the first surface and at least a portion of the second surface. In some implementations, the at least one antenna bracket includes a portion extending along a side surface of the middle frame and a portion extending along a top surface and/or a bottom surface of the middle frame, and the antenna radiator is disposed on at least a portion of the antenna bracket. In some implementations, the at least two antenna brackets include a first part disposed adjacent to a side surface of the middle frame and a second part disposed adjacent to a top surface of the middle frame, and the antenna radiator is disposed on at least a portion of the antenna bracket.

In the example shown in FIG. 7, a hatched area represents the antenna radiator 12. As can be seen, the antenna radiator 12 includes a portion located on the upper surface of the antenna bracket 112 and a portion located on the side surface of the antenna bracket 112. The portion located on the upper surface of the antenna bracket may substantially cover the entire upper surface of the antenna bracket 112, while the portion located on the side surface of the antenna bracket 112 does not fully cover the side surface of the antenna bracket 112. Therefore, the surface area of the antenna bracket 112 is greater than the coverage area of the antenna radiator 12, which facilitates the antenna bracket 112 accommodating the antenna radiators 12 associated with different frequency bands as required, and increases an application scenario of the wearable device.

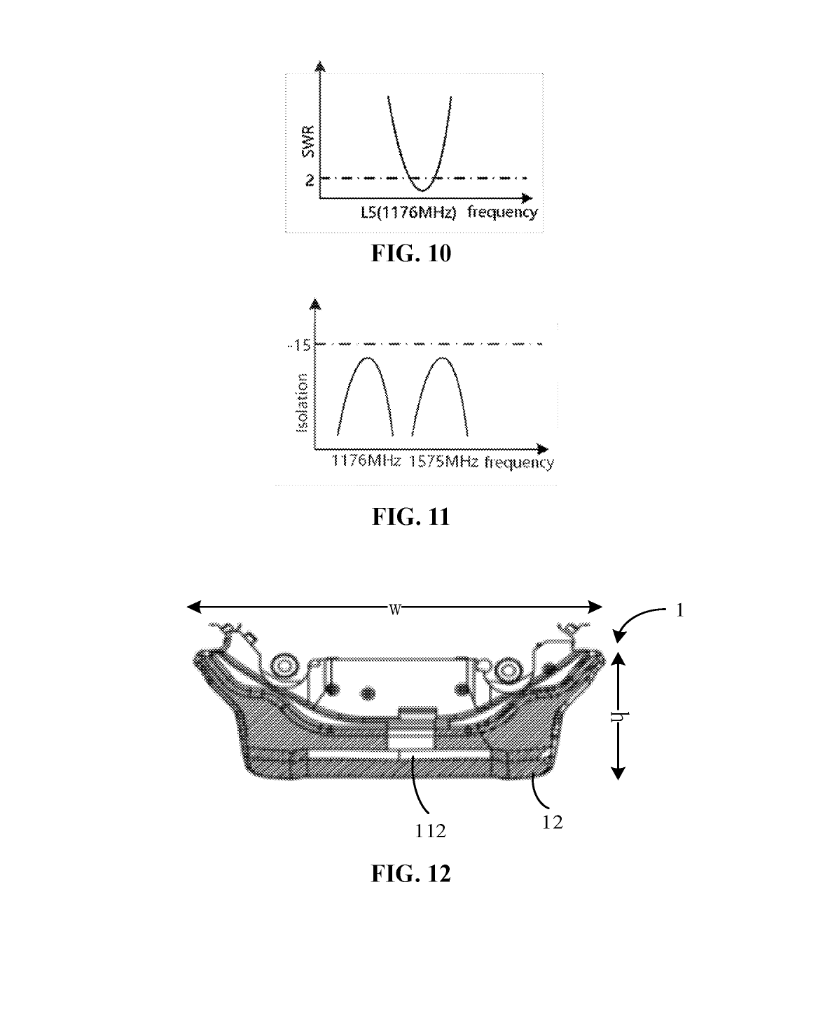

In the example shown in FIG. 7, the at least two positioning antennas with different operating frequency bands are quarter-wavelength antennas. By adjusting the height dimension h and/or the width dimension w of the antenna radiator 12, the at least two positioning antennas with different operating frequency bands are formed, each being a quarter-wavelength antenna. In this way, by configuring the positioning antenna as a quarter-wavelength antenna, that is, by setting a length of the antenna to be a quarter of the electromagnetic wavelength, excellent transmission and reception conversion efficiencies of the positioning antenna are achieved. Therefore, by arranging the first positioning antenna associated with the GPS L1 frequency band and the second positioning antenna associated with the GPS L5 frequency band separately, each can be provided with a suitable radiator shape to satisfy the λ/4 antenna condition, which is more conducive to making the current nulls of the two antennas being symmetrical (as shown in FIG. 8), thereby allowing each antenna to achieve its optimal performance while maintaining good isolation. In addition, the antennas with different frequency bands are all configured to meet the λ/4 antenna condition, which yields a lower standing wave ratio (SWR), enabling most of the energy to be transmitted into free space with a low return loss, as shown in FIG. 9 and FIG. 10. The standing wave ratio is a ratio between a reflection coefficient and a transmission coefficient of electromagnetic waves in the antenna.

FIG. 12 shows another implementation of the antenna structure for the wearable device 1. The example shown in FIG. 12 is similar to the example shown in FIG. 7, with a primary difference lying in that the antenna radiator 12 is disposed in different regions of the antenna bracket 112, so as to form antenna radiators of different shapes and antennas operating on different frequency bands.

In the example shown in FIG. 12, the antenna radiator 12 is disposed on the upper surface and the side surface of the antenna bracket 112. The portion of the antenna radiator 12 on the upper surface of the antenna bracket 112 includes two regions spaced apart, and the portion of the antenna radiator 12 on the side surface of the antenna bracket 112 includes three regions forming a specific, generally U-shape, configuration. In FIG. 12, a coverage area of the antenna radiator 12 on the antenna bracket 112 is different from that in the example of FIG. 7, and the antenna radiator 12 has a different shape, enabling the realization of antennas with different frequency bands. In this way, the antenna radiator may be disposed on the surface of the antenna bracket 112 based on a structure of the antenna bracket 112 and a required operating frequency band, offering greater flexibility and more application scenarios.

FIG. 13 shows another implementation of the antenna structure for the wearable device 1. The example shown in FIG. 13 is similar to the example shown in FIG. 7, with a primary difference lying in the placement of the antenna radiator 12 on the antenna bracket 112, so as to form antenna radiators of different shapes and antennas associated with different operating frequency bands.

In the example shown in FIG. 13, a region in which the antenna radiator 12 is disposed on the antenna bracket 112 is different from that in the example of FIG. 7. In the antenna structure of FIG. 13 compared to FIG. 7, there is a greater portion of the antenna radiator 12 on the side surface of the antenna bracket 112 and a fewer portion of the antenna radiator 12 on the upper surface of the antenna bracket 112, thus the operating frequency band of the resulting positioning antenna is adjusted.

FIG. 14 shows another implementation of the antenna structure for the wearable device 1. The example shown in FIG. 14 is similar to the example shown in FIG. 7, with a primary difference lying in the placement region of the antenna radiator 12 on the antenna bracket 112, so as to form antenna radiators of different shapes and antennas associated with different operating frequency bands.

In the example shown in FIG. 14, the antenna radiator 12 substantially covers the entire side surface of the antenna bracket 112, while not fully covering the upper surface of the antenna bracket 112. Therefore, compared to FIG. 7, the antenna radiator 12 in FIG. 14 covers a smaller portion of the upper surface of the antenna bracket 112 and a larger portion of the side surface of the antenna bracket 112. The area covered by the antenna radiator 12 on the antenna bracket 112 in this example differs from that in the example of FIG. 7, resulting in an antenna operating on a different frequency band.

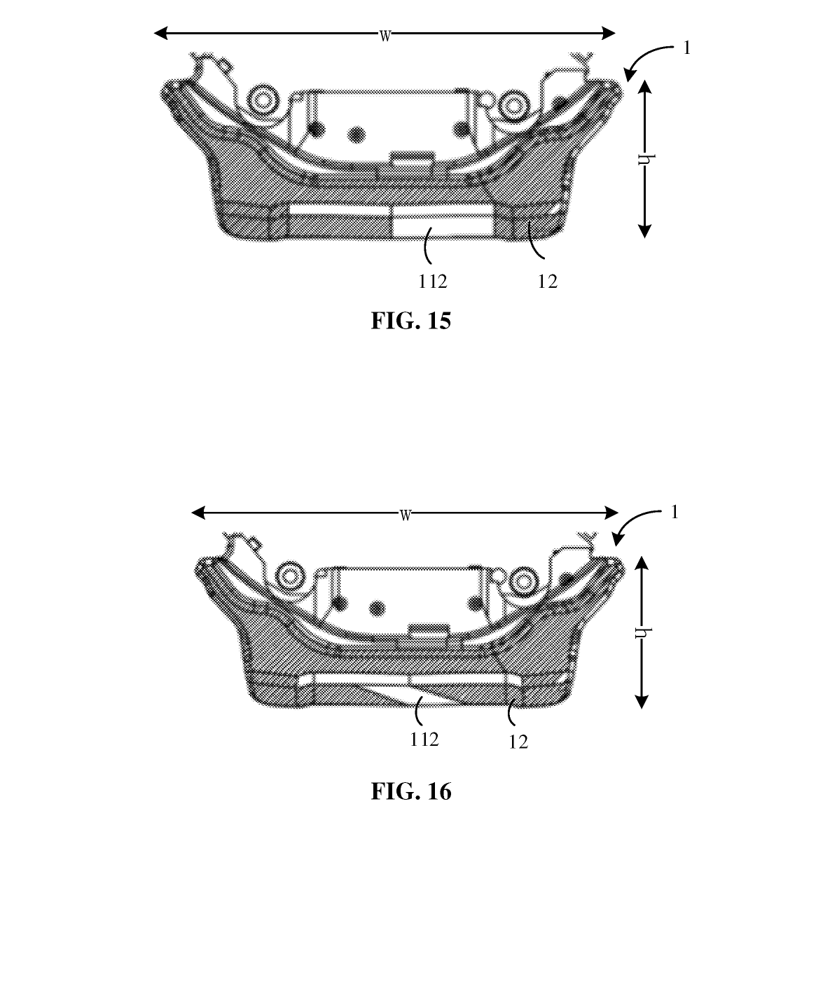

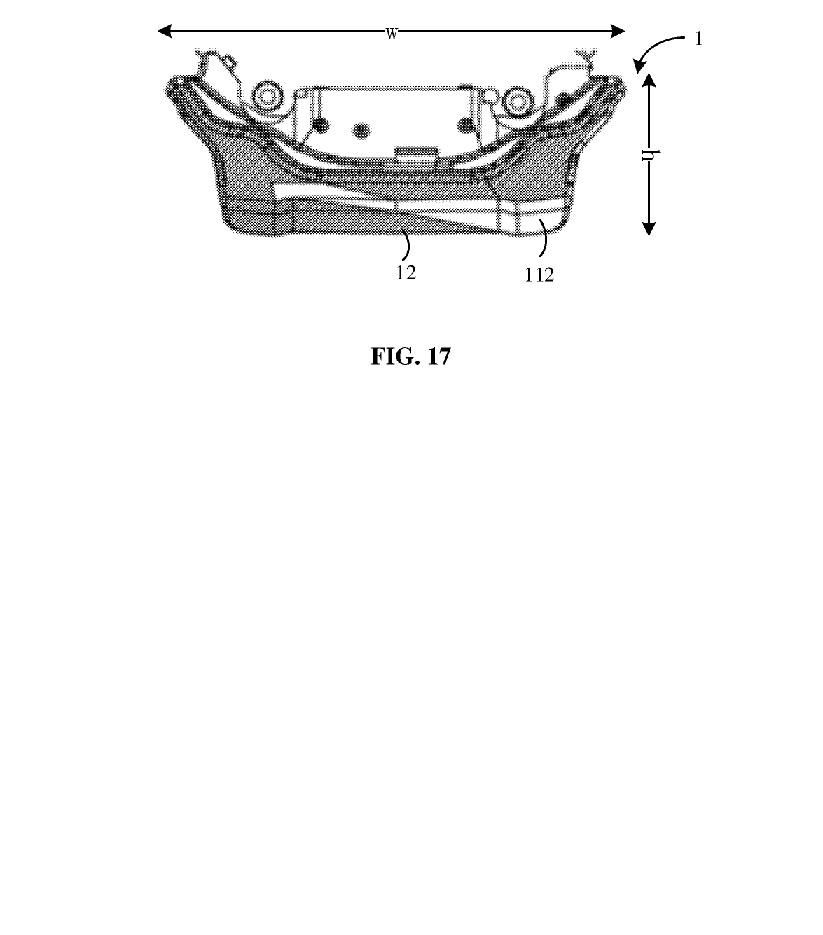

FIGS. 15 to 17 show some other implementations of the antenna structure for the wearable device 1. By adjusting the coverage area of the antenna radiator 12 on the antenna bracket 112, antenna radiators with specific shapes and antennas with different frequency bands are formed. For different frequency bands, the antenna radiator 12 may be flexibly printed on the surface of the antenna bracket 112 based on a structure of the antenna bracket 112, offering higher flexibility and more application scenarios.

In the examples shown in FIGS. 12 to 17, the antenna radiator 12 is disposed on a surface of the antenna bracket 112, and based on a specific structure of the antenna bracket 112, a corresponding operating frequency band may be implemented through an appropriate radiator shape, offering a wide range of applications, which is not limited in the present disclosure. It should be noted that FIGS. 12 to 17 schematically show the arrangement of the antenna radiator 12 in a lower half part of the wearable device, e.g., around the 6 o'clock position. The arrangement of the antenna radiator in an upper half part of the wearable device, e.g., around the 12 o'clock position, may also adopt any one of the configurations shown in FIGS. 12 to 17 or any other suitable configuration as required.

In some implementations, in addition to covering the upper surface and the side surface, the antenna radiator may be further disposed on at least one of the left or right side surface or the lower surface of the antenna bracket as required. The antenna bracket is designed in a three-dimensional configuration to facilitate the design of the shape of antenna radiator according to the requirements.

In some implementations of the present disclosure, a method for manufacturing a wearable device is provided, including: providing an antenna bracket; disposing an antenna radiator on at least one surface of the antenna bracket to obtain an antenna assembly; injection molding the antenna assembly into a middle frame of the wearable device to obtain a middle frame; and assembling the middle frame with a bottom case to obtain the wearable device.

In some implementations, disposing the antenna radiator on the at least one surface of the antenna bracket to obtain the antenna assembly includes: forming the antenna radiator on the at least one surface of the antenna bracket through a printing direct structure process to obtain the antenna assembly.

In some implementations, disposing the antenna radiator on the at least one surface of the antenna bracket to obtain the antenna assembly includes: forming the antenna radiator on the at least one surface of the antenna bracket through an etching process to obtain the antenna assembly.

In some implementations, disposing the antenna radiator on the at least one surface of the antenna bracket to obtain the antenna assembly includes: forming the antenna radiator on the at least one surface of the antenna bracket through a plating process to obtain the antenna assembly.

In some implementations, disposing the antenna radiator on the at least one surface of the antenna bracket to obtain the antenna assembly includes: forming the antenna radiator on the at least one surface of the antenna bracket through a molding process to obtain the antenna assembly.

In some implementations, disposing the antenna radiator on the at least one surface of the antenna bracket to obtain the antenna assembly includes: forming the antenna radiator on the at least one surface of the antenna bracket through a hand lay-up process to obtain the antenna assembly.

In some implementations, molding the antenna assembly into the middle frame of the wearable device to obtain the middle frame assembly includes: symmetrically molding the at least two antennas into the middle frame of the wearable device to obtain the middle frame.

In some implementations, the at least two antennas are associated with different operating frequency bands.

In some implementations, the at least two antennas include a single-band antenna and a dual-band antenna.

In some implementations, the operating frequency band of the single-band antenna includes the GPS L1 frequency band, and the operating frequency band of the dual-band antenna includes the GPS L5 frequency band and a 2.4 GHz wireless communication frequency band.

In some implementations, the at least two antennas differ in at least one of shapes of the antenna radiators or placements of the antenna radiators on the antenna brackets.

In some implementations, the at least two antennas include a first positioning antenna operating in the GPS L1 frequency band and a second positioning antenna operating in the GPS L5 frequency band.

In some implementations, the current null of the electromagnetic field generated by the first positioning antenna operating on the GPS L1 frequency band is symmetrical to those generated by the second positioning antenna operating on the GPS L5 frequency band.

In some implementations, the field strength of the electromagnetic field generated by the first positioning antenna operating on the GPS L1 frequency band is strongest in the region where the first positioning antenna is located, and is weakest in the region where the second positioning antenna is located.

In some implementations, the field strength of the electromagnetic field generated by the second positioning antenna operating on the GPS L5 frequency band is strongest in the region where the second positioning antenna is located, and is weakest in the region where the first positioning antenna is located.

In some implementations, a first antenna radiator of the at least two antenna radiators is multiplexed to serve as both a positioning antenna and a wireless communication antenna, for example, a wireless communication antenna operating on a 2.4 GHz frequency band. An antenna operating in the 2.4 GHz frequency band may be an antenna configured for short-range wireless communications, such as WiFi, Bluetooth, or Zigbee or the like.

In some implementations, the at least two positioning antennas are quarter-wavelength antennas.

In some implementations, assembling of the middle frame and the bottom case to obtain the wearable device includes: assembling the middle frame and the bottom case to form an accommodating space, and disposing a main board within the accommodating space to contact with the antenna assembly, such that the wearable device is obtained.

In some implementations, the antenna bracket is a plastic bracket. In some implementations, the antenna bracket has a three-dimensional structure.

It will be apparent to those skilled in the art that various modifications and variations can be made based on the disclosure herein without departing from the present disclosure. The present disclosure is intended to cover all such modifications, variations, and equivalents that fall within the scope of the appended claims and their legal equivalents.

The embodiments were chosen and described to best explain the principles of the present disclosure and its practical applications. The present disclosure is defined solely by the claims as set forth below.

What is claimed is:

1. A wearable device, comprising:
a housing comprising a bottom case and a middle frame formed from an electrically insulating material;
an antenna assembly, comprising:
at least two antenna brackets symmetrically disposed at the middle frame relative to a center of the middle frame; and
at least two antenna radiators, each of the at least two antenna radiators disposed on a corresponding one of the at least two antenna brackets; and
a main board, electrically connected to the at least two antenna radiators to form at least two positioning antennas associated with different operating frequency bands, wherein each of the at least two positioning antennas is configured on a different one of the at least two antenna brackets.

2. The wearable device according to claim 1, wherein the at least two positioning antennas comprise a first positioning antenna operating in a GPS L1 frequency band and a second positioning antenna operating in a GPS L5 frequency band.

3. The wearable device according to claim 2,
wherein a field strength of an electromagnetic field generated by the first positioning antenna is strongest in a region where the first positioning antenna is located, and is weakest in a region where the second positioning antenna is located; or
wherein a field strength of an electromagnetic field generated by the second positioning antenna is strongest in a region where the second positioning antenna is located, and is weakest in a region where the first positioning antenna is located.

4. The wearable device according to claim 2,
wherein a current null of an electromagnetic field generated by the second positioning antenna is symmetrical to that of an electromagnetic field generated by the first positioning antenna.

5. The wearable device according to claim 1, wherein the at least two antenna radiators are respectively formed on surfaces of the at least two antenna brackets through a print direct structure process.

6. The wearable device according to claim 1, wherein each of the at least two antenna brackets is integrally formed with a corresponding one of the at least two antenna radiators.

7. The wearable device according to claim 1, wherein the at least two positioning antennas are quarter-wavelength antennas.

8. The wearable device according to claim 1, wherein at least one of:
a first antenna radiator of the at least two antenna radiators is configured to form a first positioning antenna of the at least two positioning antennas; or
a second antenna radiator of the at least two antenna radiators is configured to form a second positioning antenna of the at least two positioning antennas and a wireless communication antenna.

9. The wearable device according to claim 1, wherein at least one of:
the at least two antenna brackets are formed from a material suitable for injection molding; or
the at least two antenna brackets are disposed within the housing through an injection molding process.

10. The wearable device according to claim 1, wherein
the main board comprises a plurality of feeding terminals and a plurality of grounding terminals, and each of the at least two antenna radiators comprises at least one feeding point and at least one grounding point, the at least one feeding point being electrically connected to at least one of the plurality of feeding terminals, and the at least one grounding point being electrically connected to at least one of the plurality of grounding terminals.

11. The wearable device according to claim 1, wherein
the bottom case is formed from an electrically insulating material, and comprises a plurality of electrically conductive components electrically connected to the main board, and
at least one of the at least two antenna radiators is electrically connected to the main board through at least one of the plurality of electrically conductive components.

12. The wearable device according to claim 1, further comprising a wearable attachment for securing the wearable device to a user;
wherein the housing comprises at least one connection portion adapted to connect to the wearable attachment, and at least one of the at least two antenna brackets is disposed in the at least one connection portion.

13. The wearable device according to claim 1, wherein the at least two antenna brackets and the at least two antenna radiators are integrally formed with the middle frame.

14. The wearable device according to claim 1, wherein at least one of:
at least one of the at least two antenna brackets comprises a first surface and a second surface, and each antenna radiator is disposed on at least a portion of the first surface and at least a portion of the second surface; or
at least one of the at least two antenna brackets comprises a portion extending along a side surface of the middle frame and a portion extending along at least one of a top surface or a bottom surface of the middle frame.

15. The wearable device according to claim 1, wherein
the at least two antenna brackets comprise a first bracket and a second bracket, the first bracket being positioned at a 6 o'clock direction of a dial of the wearable device, the second bracket being positioned at a 12 o'clock direction of the dial;
a first antenna radiator on the first bracket operates in a GPS L1 frequency band, and
a second antenna radiator on the second bracket operates in a GPS L5 frequency band and a wireless communication frequency band centered approximately at 2.4 GHz.

16. The wearable device according to claim 1, wherein each of the at least two antenna brackets defines at least one opening configured to accommodate a spring bar for connecting a wearable attachment.

17. The wearable device according to claim 1, further comprising a screen assembly disposed on a top surface of the middle frame, and the at least two antenna brackets comprise a first portion positioned adjacent to a side surface of the middle frame and a second portion positioned adjacent to the top surface of the middle frame.

18. The wearable device of claim 1, wherein the main board is positioned in a space between the at least two antenna brackets and the bottom case.

19. The wearable device according to claim 1, wherein a plurality of metal elastic pieces are disposed on the main board, and the plurality of metal elastic pieces extend from the main board to a top surface of the housing and are in contact with the at least two antenna radiators.

20. A method for manufacturing a wearable device, comprising:
providing an antenna bracket;
obtaining an antenna assembly by disposing an antenna radiator on at least one surface of the antenna bracket;
obtaining a middle frame by injection molding the antenna assembly into a middle frame of the wearable device; and
assembling the middle frame with a bottom case to obtain the wearable device.
